(19) United States
(12) Patent Application Publication
(10) Pub. No.: US 2026/0056082 A1
(43) Pub. Date: Feb. 26, 2026

(54) MONITORING AND SAFETY ASSESSMENT SYSTEM USING A DEEP GEOLOGICAL DISPOSAL FACILITY SIMULATION DEVICE FOR SPENT NUCLEAR FUEL

(71) Applicant: KOREA RADIOACTIVE WASTE AGENCY, Gyeongju-si (KR)

(72) Inventors: Ji Seon JANG, Yuseong-gu (KR); Jeong Hwan LEE, Yuseong-gu (KR); Mi Seon JEONG, Yuseong-gu (KR); Chang Min SHIN, Yuseong-gu (KR); Hyung Joo YUN, Yuseong-gu (KR); Seo Yeon CHO, Yuseong-gu (KR)

(21) Appl. No.: 19/060,500

(22) Filed: Feb. 21, 2025

(30) Foreign Application Priority Data
Aug. 21, 2024 (KR) 10-2024-0112194

(51) Int. Cl. G01M 3/20; G21F 9/34

(52) U.S. Cl. CPC G01M 3/202; G21F 9/34

(57) ABSTRACT

Provided is a monitoring and safety assessment system using a deep geological disposal facility simulation device for spent nuclear fuel for simulating the deep geological disposal facility for spent nuclear fuel and assessing safety by monitoring, wherein the monitoring and safety assessment system comprises: a deep geological disposal facility simulation device for simulating the actual environment where the spent nuclear fuel is disposed of; a state information detection part for monitoring temperature and pressure of the deep geological disposal facility simulation device in real time and detecting liquid and gas of leaked radionuclide; a data collection part for collecting detected information from the state information detection part as data for analysis; and a safety assessment part for conducting an assessment of stability of deep geological disposal facilities by analyzing and assessing analysis data, collected from the data collection part.

### TECHNICAL FIELD

The present invention relates to a monitoring and safety assessment system using a deep geological disposal facility simulation device for spent nuclear fuel and, more specifically, to a monitoring and safety assessment system using a deep geological disposal facility simulation device for spent nuclear fuel for simulating deep geological disposal facilities for spent nuclear fuel and assessing safety through monitoring.

### BACKGROUND ART

Deep geological disposal refers to storages of radioactive waste to a deep and safe geological structure and permanent isolation from people's lives for the purpose of imposing restrictions on people's approach and radionuclide inflow of environment. Such deep geological disposal facilities should conduct continuous step-by-step safety assessment based on updated information in accordance with step-by-step purposes throughout whole steps of construction, operation, shutdown, follow-up management after shutdown, etc.

High-level radioactive deep geological disposal facilities consist of a multiple barrier system having an engineered barrier such as a canister, buffer, backfill, etc., and a natural barrier which is approximately more than 500 meters depth of bedrock, for preventing migration of radionuclide, contained in spent nuclear fuel, and leakage to the environment, thereby not affecting the environment in spite of nuclide leakage.

The top priority in geological disposal of spent nuclear fuel is to attain thermally, mechanically, hydraulically and chemically long-term safety. Obtaining safety assessment technology of deep geological disposal facilities is an essential research field in promoting high-level radioactive waste management industry in the nation and thus, a method for assessing disposal safety in consideration of national environment and situations should be configured.

However, sites for deep geological disposal facilities and design standards have not yet established domestically. Thus, it is difficult to obtain input data which considers domestic situations and to rarely conduct a research for input data for safety assessment of deep geological facilities domestically.

Meanwhile, prior arts on processing of spent nuclear fuel have been disclosed in Patent Document 1 to 6.

Patent Document 1 discloses a deep disposal of radioactive waste simulating apparatus for simulating transport of nuclides and solute due to proliferation, based on concentration gradient, and inflow of underground water anticipated in deep disposal environment. However, it is impossible to continuously monitor radionuclide transport and leakage generated from high temperature spent nuclear fuel and not to conduct safety assessment.

Further, Patent Document 2 discloses a deep disposal of radioactive waste gas behavior simulating apparatus for testing behavior of gas and nuclide containing fine particles in deep disposal environment of high temperature and pressure. However, monitoring and safety assessment is insufficient.

Further, Patent Document 3 refers to a technology for simulating and monitoring conditions of real deep bedrock by injecting radionuclide and underground water to a tube and measuring electrically variable properties for each position of deep bedrock. However, it is impossible to conduct monitoring and safety assessment of transport and leakage of radionuclide generated from spent nuclear fuel.

Further, Patent Document 4 discloses an underground water flow characteristics monitoring system for grouting of displacement tunnel excavation for underground disposal of radioactive waste. It may be possible to monitor underground water flow characteristics for grouting of tunnel excavation, but it is impossible to conduct monitoring and safety assessment of transport and leakage of radionuclide generated from spent nuclear fuel.

Further, Patent Document 5 refers to a technology for evaluating disposal facility of radioactive waste and merely discloses conditions for evaluating disposal facility of radioactive waste. It does not provide a simulating apparatus for deep geological facilities of spent nuclear fuel and it is impossible to evaluation safety through transport and leakage of radionuclide generated from spent nuclear fuel.

Further, Patent Document 6 refers to safety assessment method and system for radioactive waste complex disposal facility. It does not provide a simulating apparatus for deep geological facilities of spent nuclear fuel and it is impossible to evaluation safety through transport and leakage of radionuclide generated from spent nuclear fuel.

Accordingly, a simulation device for implementing environment for deep geological facilities of real spent nuclear fuel and verifying transport of radionuclide, followed by underground water inflow after shutdown of disposal facilities, and design suitability has been required. Utilizing such simulation device, a technology for assessing safety through continuous monitoring has been demanded.

### PRIOR ART

(Patent document 001) Korean Patent Registration No. 10-2631902 (DEEP DISPOSAL OF RADIOACTIVE WASTE SIMULATING APPARATUS)
(Patent document 002) Korean Patent Registration No. 10-2640319 (DEEP DISPOSAL OF RADIOACTIVE WASTE GAS BEHAVIOR SIMULATING APPARATUS)
(Patent document 003) Korean Patent Registration No. 10-2424319 (SYSTEM FOR MONITORING ELECTRICAL PROPERTIES OF MATERIALS OF DEEP BEDROCK SAMPLES FOR ESTIMATING NUCLIDE MOVEMENT IN DISPOSAL SITE OF SPENT FUEL)
(Patent document 004) Korean Patent Registration No. 10-1433877 (UNDERGROUND WATER FLOW CHARACTERISTICS MONITORING SYSTEM FOR GROUTING OF DISPLACEMENT TUNNEL EXCAVATION FOR UNDERGROUND DISPOSAL OF RADIOACTIVE WASTE)
(Patent document 005) Korean Patent Registration No. 10-1714029 (SYSTEM AND METHOD FOR EVALUATING DISPOSAL FACILITY OF RADIOACTIVE WASTE)
(Patent document 006) Korean Patent Registration No. 10-2292468 (SAFETY ASSESSMENT METHOD AND SYSTEM FOR RADIOACTIVE WASTE COMPLEX DISPOSAL FACILITY)

### DISCLOSURE

### Technical Problem

Accordingly, the object of the present invention is to improve the problem in which monitoring and safety assessment of common deep geological disposal facility for spent nuclear fuel are not conducted. Then, the object of the present invention is to provide a monitoring and safety assessment system using a deep geological disposal facility simulation device for spent nuclear fuel for simulating deep geological disposal facilities for spent nuclear fuel, monitoring and collecting data by sensors, and conducting safety assessment.

### Technical Solution

To accomplish above objects, a monitoring and safety assessment system using a deep geological disposal facility simulation device for spent nuclear fuel according to the present invention comprises: a deep geological disposal facility simulation device for simulating the actual environment where the spent nuclear fuel is disposed of; a state information detection part for monitoring temperature and pressure of the deep geological disposal facility simulation device in real time and detecting liquid and gas of leaked radionuclide; a data collection part for collecting detected information from the state information detection part (120) as data for analysis; and a safety assessment part for conducting an assessment of stability of deep geological disposal facilities by analyzing and assessing analysis data, collected from the data collection part.

Desirably, the deep geological disposal facility simulation device consists of a deep geological disposal facility for isolating spent nuclear fuel; a column to which the deep geological disposal facility is equipped; a chamber for performing isothermal-isohumidity control with the column; a supply pump for being placed to the bottom of the column and supplying test liquid, which mixes underground water and radionuclide liquid, to a storage tank for embodying spent nuclear fuel; and a storage pump for being placed to the top of the column and storing test liquid, which goes through the deep geological disposal facility in the column, to a storage tank.

Desirably, in the deep geological disposal facility, a canister, buffer, backfill, a supercontainer and a host rock simulating member are stacked in order from the bottom to the top.

Desirably, the state information detection part comprises a temperature and pressure detection part for monitoring temperature and pressure of the deep geological disposal facility simulation device in real time; and a liquid and gas detection part for detecting liquid and gas which are leaked out of the deep geological disposal facility simulation device.

Desirably, the liquid and gas detection part analyzes concentration of radionuclide by using the detected liquid sample through Inductively Coupled Plasma Mass Spectrometry (ICP-MS) and/or High Performance Liquid Chromatography (HPLC), and outputs detection data of concentration of radionuclide and detection data of concentration of gas after analyzing the detected gas sample through Gas Chromatography Mass Spectrometry (GC-MS).

Desirably, the data collection part records and collects temperature and pressure, detected from the state information detection part, by using a Lab View program and collects liquid and gas analysis data through the state information detection part and data transmission mode.

Desirably, the data collection part maps liquid and gas analysis data and temperature and pressure collection data, thereby transferring to the safety assessment part.

Desirably, the safety assessment part extracts only data for safety assessment from temperature data, pressure data, and liquid and gas analysis data which are collected by a Lab View program, and conducts an assessment on the safety of the extracted data based on scenario which may happen in the future in deep geological disposal environment.

Desirably, the safety assessment part analyzes radionuclide transport mechanism of the collected data for multiple barriers based on nuclide transport model and performs radiological safety assessment, while the safety assessment is to assess influence on human and ecosystem due to radionuclide in overall consideration of objects, routes, time, etc., of exposure based on expectable scenario that may be occurred in the future.

### Advantageous Effects

The present invention enables to optimally simulate a deep geological facility for spent nuclear fuel and an actual deep geological facility for spent nuclear fuel in an extremely similar manner. Also, it enables to provide data which designs concepts and verifies data upon establishing a deep geological disposal facility by monitoring and assessing safety through such simulation device.

### DESCRIPTION OF DRAWINGS

FIG. 1 illustrates a block diagram showing a monitoring and safety assessment system using a deep geological disposal facility simulation device for spent nuclear fuel according to desirable embodiments of the present invention.

FIG. 2A illustrates an example drawing showing a deep geological disposal facility simulation device for spent nuclear fuel which is applied to the present invention.

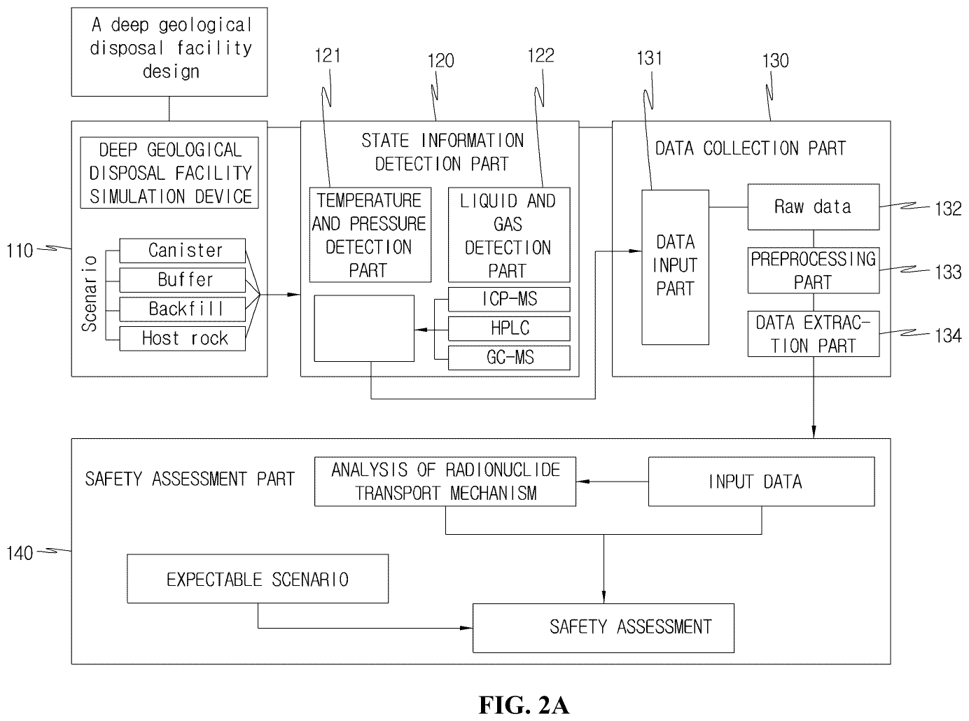

FIG. 2B illustrates a drawing showing a blank block of FIG. 2A.

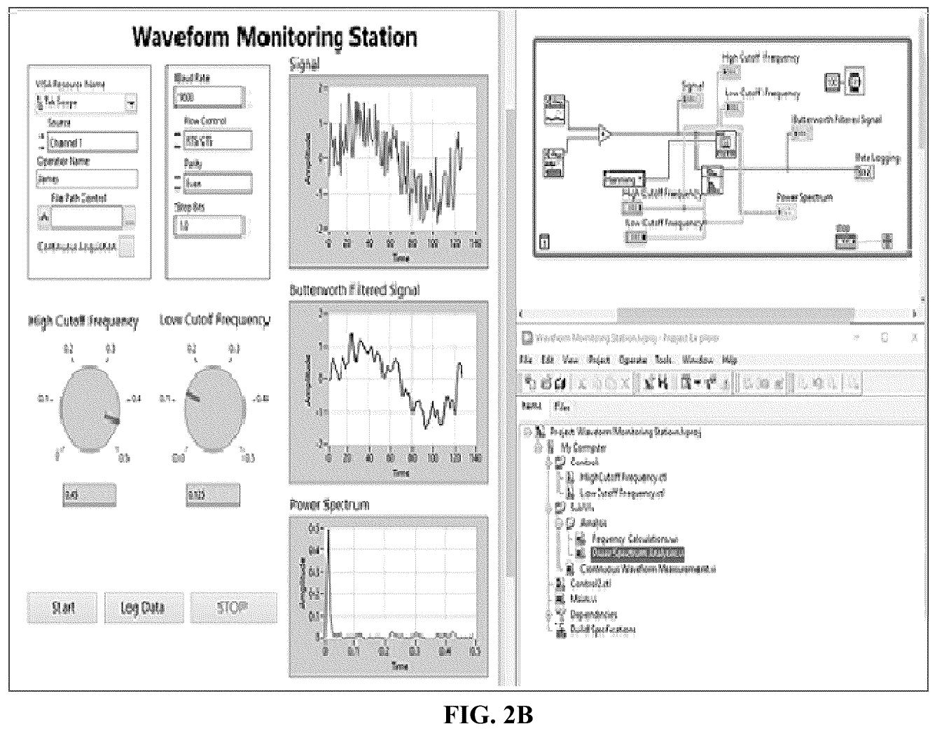

FIG. 3A illustrates an enlarged drawing showing left description of FIG. 2B.

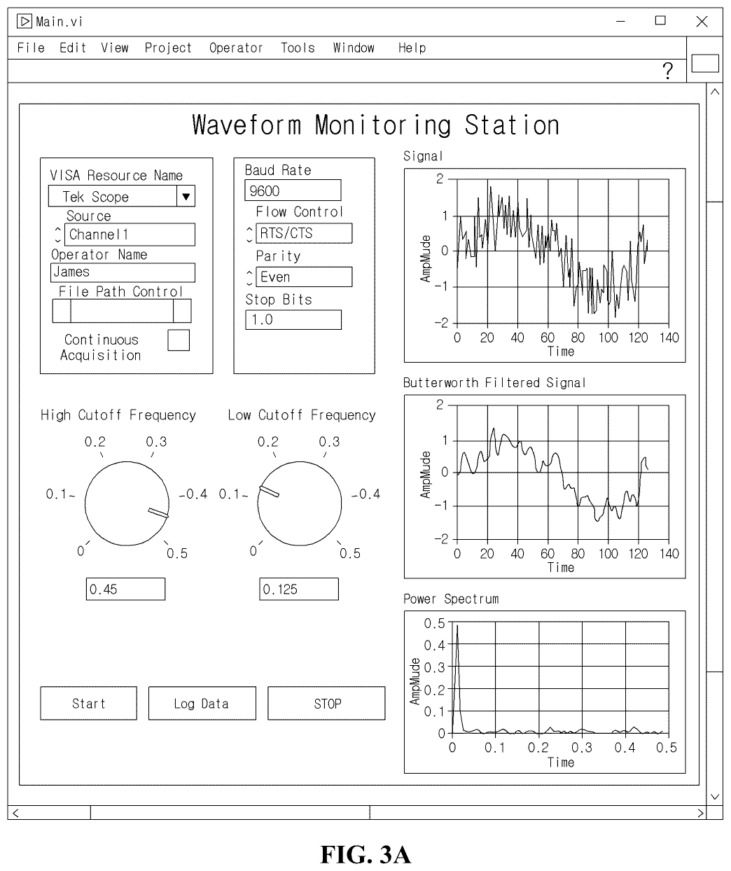

FIG. 3B illustrates an enlarged drawing showing right description of FIG. 2B.

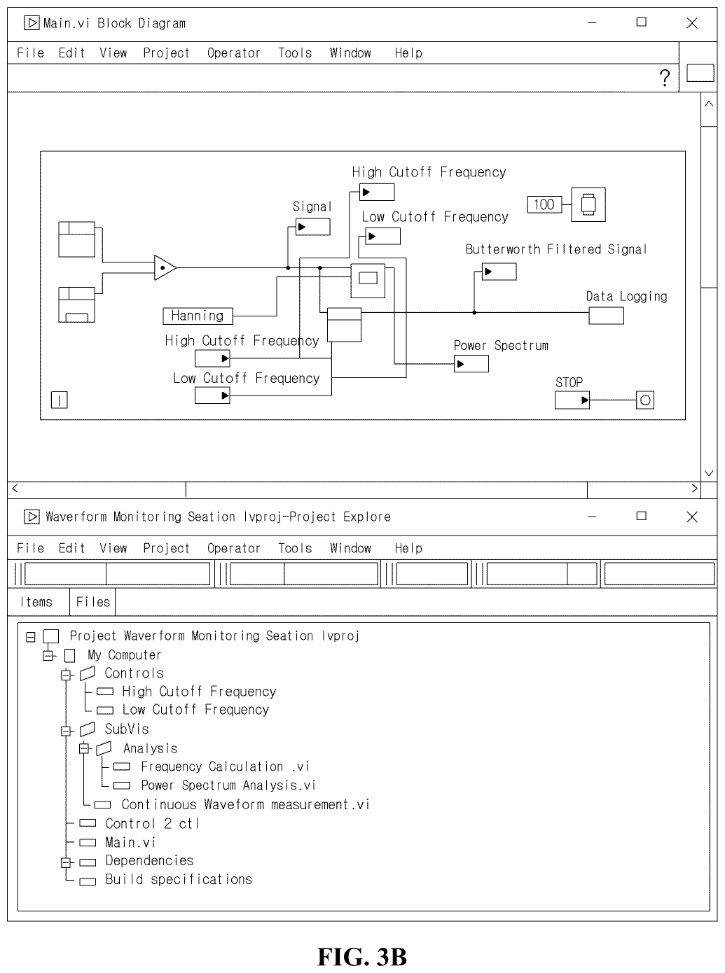

### DESCRIPTION OF THE PREFERRED EMBODIMENTS

The configuration of a monitoring and safety assessment system using a deep geological disposal facility simulation device for spent nuclear fuel of the present invention will be described in detail with the accompanying drawings.

In the following description of the present invention, a detailed description of known incorporated functions and configurations will be omitted when to include them would make the subject matter of the present invention rather unclear. Also, the terms used in the following description are defined taking into consideration the functions provided in the present invention. The definitions of these terms should be determined based on the whole content of this specification, because they may be changed in accordance with the option of a user or operator or a usual practice.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

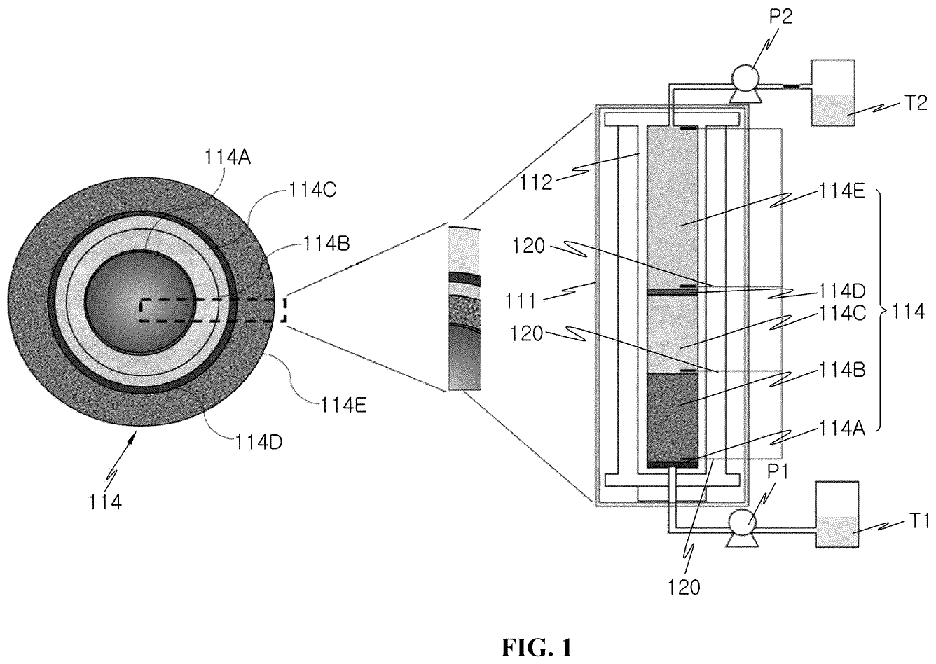

FIG. 1 illustrates a block diagram showing a monitoring and safety assessment system using a deep geological disposal facility simulation device for spent nuclear fuel according to desirable embodiments of the present invention, wherein a deep geological disposal facility simulation device (110), a state information detection part (120), a data collection part (130) and a safety assessment part (140) are included.

The deep geological disposal facility simulation device (110) simulates the actual environment of a deep geological disposal facility where the spent nuclear fuel is disposed of.

The deep geological disposal facility simulation device (110) simulates and monitors the environment identical to that of the deep geological disposal facility for spent nuclear fuel, and accurately assesses safety indirectly for obtaining long-term high safety and superior consistency while not affecting the ground in spite of nuclide leakage as well as controlling the transport of radioactive material, contained in spent nuclear fuel in actual deep geological disposal facility, and contact of underground water at most.

The deep geological disposal facility simulation device (110) simulates high-temperature and high-pressure environment for simulating the actual geological disposal environment.

As illustrated in FIG. 1, the deep geological disposal facility simulation device (110) consists of a deep geological disposal facility (114) for isolating spent nuclear fuel; a column (112) to which the deep geological disposal facility (114) is equipped; a chamber (111) for performing isothermal-isohumidity control with the column (112); a supply pump (P1) for being placed to the bottom of the column (112) and supplying test liquid, which mixes underground water and radionuclide liquid, to a storage tank (T1) for embodying spent nuclear fuel; and a storage pump (P2) for being placed to the top of the column (112) and storing test liquid, which goes through the deep geological disposal facility (114) in the column (112), to a storage tank (T2).

In the deep geological disposal facility (114), a canister (114A), buffer (114B), backfill (114C), a supercontainer (114D) and a host rock (114E) simulating member may be stacked in order from the bottom to the top.

Radionuclide is leaked out at high and low temperature with heat source generated from spent nuclear fuel; a metal container (canister) (114A) is simulated using copper and iron coated membrane; and compressed bentonite for the buffer (114B) and granular bentonite for the backfill (114C) are filled in the column (112). Titanium coated membrane is filled in the supercontainer (114D) and granite is filled in the host rock (114E).

For unifying environmental condition of the deep geological disposal facility as a whole, the internal condition of the column is identically applied by utilizing isothermal-isohumidity chambers (111).

Double or triple tests may be conducted for assessing influence of spent nuclear fuel consecutively connected.

The state information detection part (120) monitors temperature and pressure of the deep geological disposal facility simulation device (110) in real time and detects liquid and gas of leaked radionuclide.

The state information detection part (120) may include a temperature and pressure detection part (121) for monitoring temperature and pressure of the deep geological disposal facility simulation device (110) in real time; and a liquid and gas detection part (122) for detecting liquid and gas which are leaked out of the deep geological disposal facility simulation device (110).

Desirably, the liquid and gas detection part (122) may analyze concentration of radionuclide by using the detected liquid sample through Inductively Coupled Plasma Mass Spectrometry (ICP-MS) and/or High Performance Liquid Chromatography (HPLC), and output detection data of concentration of radionuclide and detection data of concentration of gas after analyzing the detected gas sample through Gas Chromatography Mass Spectrometry (GC-MS).

The data collection part (130) collects detected information from the state information detection part (120) as data for analysis.

The data collection part (130) may record and collect temperature and pressure, detected from the state information detection part (120), by using a Lab View program and collect liquid and gas analysis data through the state information detection part (120) and data transmission mode.

Desirably, the data collection part (130) may map liquid and gas analysis data and temperature and pressure collection data, thereby transferring to the safety assessment part (140).

The data collection part (130) may comprise a data input part (131) for inputting temperature and pressure data and liquid and gas analysis data as analysis data by being interconnected with the state information detection part (120); a data output part (132) for outputting data, inputted in the data input part (131), as raw data; a preprocessing part (133) for classifying, normalizing and filtering raw data, outputted from the data output part (132); and a data extraction part (134) for extracting temperature date, pressure data, liquid analysis data and gas analysis data from the data in the preprocessing part (133) and transferring to the safety assessment part (140).

The safety assessment part (140) conducts an assessment of stability of deep geological disposal facilities by utilizing data for analysis, collected from the data collection part (130), with using GoldSim program.

The safety assessment part (140) extracts only data for safety assessment from temperature data, pressure data, and liquid and gas analysis data which are collected by a Lab View program, and conducts an assessment on the safety of the extracted data based on scenario which may happen in the future in deep geological disposal environment.

The safety assessment part (140) may analyze radionuclide transport mechanism for multiple barriers of liquid and gas analysis data based on nuclide transport model, and perform a radiological safety assessment.

The result of the safety assessment may be expressed on the spot through a display device, or be transferred to a remote terminal by communication modules.

The operation of the monitoring and safety assessment system using a deep geological disposal facility simulation device for spent nuclear fuel according to desirable embodiments of the present invention, as constituted as above will be described in detail.

First, as illustrated in FIG. 1, the deep geological disposal facility simulation device (110) is embodied by simulating the actual environment information of the deep geological disposal facility where the spent nuclear fuel is disposed of.

That is, as illustrated in FIG. 1, the deep geological disposal facility simulation device (110) is simulated as the deep geological disposal facility (114) such as the canister (114A), the buffer (114B), the backfill (114C), supercontainer (114D), and the host rock (114E); such deep geological disposal facility (114) is consecutively stacked from the bottom in the column (112); and the column (12) is embedded with the chamber (111) again, thereby embodying the deep geological disposal facility simulation device.

Radionuclide is leaked at high/low temperature by heat source generated in spent nuclear fuel.

After establishing the deep geological disposal facility simulation device (110), temperature and pressure for each position (e.g., for each simulating member) of the deep geological disposal facility simulation device (110) are monitored in real time by the state information detection part (120), and liquid and gas of the leaked radionuclide are detected, for assessing the safety of the deep geological disposal facility (114).

The temperature and pressure detection part (121) detects temperature and pressure of the deep geological disposal facility simulation device (110) based on real-time monitoring by using a temperature sensor and a pressure sensor, commonly used. Further, the liquid and gas detection part (122) detects the liquid and gas which are leaked out of the deep geological disposal facility simulation device (110).

Desirably, the liquid and gas detection part (122) analyzes the concentration of the radionuclide, detected by Inductively Coupled Plasma Mass Spectrometry (ICP-MS) and High Performance Liquid Chromatography (HPLC), and outputs radionuclide concentration detection data and gas concentration detection data, respectively, after analyzing the gas detected by Gas Chromatography Mass Spectrometry (GC-MS).

Hereinafter, the ICP-MS is an elemental analysis technology capable of detecting most of the periodic table of elements at milligram to nanogram levels per liter. Detected liquid sample is ionized in the plasma; the ionized element is applied with RF and DC voltages in the quadrupole, thereby interconnecting electromagnetic field with ion beam; and stable trajectories have through the quadrupole based on the voltage only with a specific mass ion. At this time, only one specific ion at a time is collected and the rest is lost, thereby analyzing radionuclide concentration of the liquid sample using a range of quantitative and qualitative analysis for mass of elements.

The HPLC is a technique in isolation and detection, or qualitative analysis of tiny amount of radionuclide in solution using various detectors.

The GC-MS for gas analysis may be used to separate and identify chemical materials. Each compound in volatile gas sample is transferred at different speed. Thus, compounds are separated depending on time. The mass and structure information of the separated compound are obtained, and each compound is ionized, passing through a mass spectrometer and producing a mass spectrum. The mass spectrum provides information on molecular weight and structure of compounds. Using the spectrum, the compound and its structure are identified.

That is, the detected gas sample is appropriately processed and converted to volatile gas; the compound is separated; a positive ion or a negative ion is produced by ionization; the information of the mass and structure of the compound is obtained through mass analysis; and mass spectrum data is analyzed, thereby identifying and quantifying the compound to check the configuration.

The liquid data and gas data detected through the liquid and gas detection part (122) are transferred by communication with the temperature and pressure detection part (121), and the temperature and pressure detection part (121) delivers the detected temperature and pressure data, liquid data and gas data to the data collection part (130) by mapping based on time as analysis data.

The data collection part (130) collects the detection information (temperature data, pressure data, liquid analysis data, gas analysis data), detected from the state information detection part (120), as analysis data and delivers to the safety assessment part (140).

For example, the data collection part (130) records and collects temperature and pressure, detected from the state information detection part (120), by using a Lab View program, and the liquid and gas analysis data may be collected by the state information detection part (120) and data transmission method.

Desirably, the data collection part (130) maps the liquid and gas analysis data and the temperature and pressure collection data for delivering to the safety assessment part (140).

Interconnecting the state information detection part (120), the data collection part (130) collects the temperature and pressure data, and the liquid and gas analysis data from the data input part (131) as analysis data. Then, the data, collected from the data output part (132), is delivered to the preprocessing part (133) as raw data. The preprocessing part (133) classifies data, outputted from the data output part (132), by a type and performs the preprocessing with normalization and filtering. The preprocessing detection data is extracted as temperature data, pressure data, liquid analysis data and gas analysis data and delivered to the safety assessment part (140).

Using the analysis data, collected from the data collection part (130), based on GoldSim program, the safety assessment part (140) performs safety assessment of deep geological disposal facilities.

That is, the safety assessment part (140) may extract only data, which requires for safety assessment, from temperature data, pressure data, and liquid and gas analysis data based on the Lab View program, and analyze safety of data, extracted based on the scenario that may be occurred in the future in geological environment.

Desirably, the safety assessment part (140) analyzes radionuclide transport mechanism of the collected data for multiple barriers based on nuclide transport model and performs radiological safety assessment. The safety assessment is to assess influence on human and ecosystem due to radionuclide in overall consideration of objects, routes, time, etc., of exposure based on expectable scenario (earthquake, seal-level rise, etc.) that may be occurred in the future.

The result of the safety assessment may be expressed on the spot using display devices, or transferred to remote manager terminals (PC, servers, smartphones, etc.) through communication modules.

According to the present invention as explained above, the deep geological disposal facility may be simulated extremely optimally and similar to the real deep geological disposal facility. By monitoring through such simulation device and assessing safety, data for verifying concept design and safety may be provided, upon designing and establishing the deep geological disposal facility.

The invention derived from the inventors of the present invention is specifically explained in accordance with the embodiments. However, the present invention is not defined by the embodiments, and modification in various forms within the range of the gist of the present invention is obvious for a person in the art.

### EXPLANATIONS OF NUMERAL REFERENCE

110: deep geological disposal facility simulation device
111: chamber
112: column
114: deep geological disposal facility
120: state information detection part
121: temperature and pressure detection part
122: liquid and gas detection part
130: data collection part
131: data input part
132: data output part
133: preprocessing part
140: safety assessment part

1. A monitoring and safety assessment system using a deep geological disposal facility simulation device for spent nuclear fuel, comprising: a deep geological disposal facility simulation device for simulating the actual environment where the spent nuclear fuel is disposed of; a state information detection part for monitoring temperature and pressure of the deep geological disposal facility simulation device in real time and detecting liquid and gas of leaked radionuclide; a data collection part for collecting detected information from the state information detection part (120) as data for analysis; and a safety assessment part for conducting an assessment of stability of deep geological disposal facilities by analyzing and assessing analysis data, collected from the data collection part.

2. The monitoring and safety assessment system using a deep geological disposal facility simulation device for spent nuclear fuel according to claim 1, wherein the deep geological disposal facility simulation device consists of a deep geological disposal facility for isolating spent nuclear fuel; a column to which the deep geological disposal facility is equipped; a chamber for performing isothermal-isohumidity control with the column; a supply pump for being placed to the bottom of the column and supplying test liquid, which mixes underground water and radionuclide liquid, to a storage tank for embodying spent nuclear fuel; and a storage pump for being placed to the top of the column and storing test liquid, which goes through the deep geological disposal facility in the column, to a storage tank.

3. The monitoring and safety assessment system using a deep geological disposal facility simulation device for spent nuclear fuel according to claim 2, wherein in the deep geological disposal facility, a canister, buffer, backfill, a supercontainer and a host rock simulating member are stacked in order from the bottom to the top.

4. The monitoring and safety assessment system using a deep geological disposal facility simulation device for spent nuclear fuel according to claim 1, wherein the state information detection part comprises a temperature and pressure detection part for monitoring temperature and pressure of the deep geological disposal facility simulation device in real time; and a liquid and gas detection part for detecting liquid and gas which are leaked out of the deep geological disposal facility simulation device.

5. The monitoring and safety assessment system using a deep geological disposal facility simulation device for spent nuclear fuel according to claim 4, wherein the liquid and gas detection part analyzes concentration of radionuclide by using the detected liquid sample through Inductively Coupled Plasma Mass Spectrometry (ICP-MS) and/or High Performance Liquid Chromatography (HPLC), and outputs detection data of concentration of radionuclide and detection data of concentration of gas after analyzing the detected gas sample through Gas Chromatography Mass Spectrometry (GC-MS).

6. The monitoring and safety assessment system using a deep geological disposal facility simulation device for spent nuclear fuel according to claim 1, wherein the data collection part records and collects temperature and pressure, detected from the state information detection part, by using a Lab View program and collects liquid and gas analysis data through the state information detection part and data transmission mode.

7. The monitoring and safety assessment system using a deep geological disposal facility simulation device for spent nuclear fuel according to claim 6, wherein the data collection part maps liquid and gas analysis data and temperature and pressure collection data, thereby transferring to the safety assessment part.

8. The monitoring and safety assessment system using a deep geological disposal facility simulation device for spent nuclear fuel according to claim 1, wherein the safety assessment part extracts only data for safety assessment from temperature data, pressure data, and liquid and gas analysis data which are collected by a Lab View program, and conducts an assessment on the safety of the extracted data based on scenario which may happen in the future in deep geological disposal environment.

9. The monitoring and safety assessment system using a deep geological disposal facility simulation device for spent nuclear fuel according to claim 8, wherein the safety assessment part analyzes radionuclide transport mechanism of the collected data for multiple barriers based on nuclide transport model and performs radiological safety assessment, while the safety assessment is to assess influence on human and ecosystem due to radionuclide in overall consideration of objects, routes, time, etc., of exposure based on expectable scenario that may be occurred in the future.
